(19) United States
(12) Patent Application Publication
(10) Pub. No.: US 2023/0278906 A1
(43) Pub. Date: Sep. 7, 2023

(54) GLASS FORMING BODY AND METHOD OF MAKING A GLASS ARTICLE USING THE SAME

(71) Applicant: CORNING INCORPORATED, Corning, NY (US)

(72) Inventor: Olus Naili Boratav, Ithaca, NY (US)

(21) Appl. No.: 18/019,325

(22) PCT Filed: Sep. 10, 2021
(86) PCT No.: PCT/US2021/049802

§ 371 Date: Feb. 2, 2023

Related U.S. Application Data
(60) Provisional application No. 63/084,140, filed on Sep. 28, 2020.

(51) Int. Cl. C03B 17/06

(52) U.S. Cl. CPC C03B 17/064

(57) ABSTRACT

A glass forming body and method of making a glass article using the same. The forming body includes a first weir, a second weir, a trough extending between the first and second weirs in a horizontal direction and below the first and second weirs in a vertical direction, a first inner surface extending between the first weir and the trough, and a second inner surface extending between the second weir and the trough, each of first and second inner surfaces extending along an axis oriented at an angle of greater than 0° relative to the vertical direction.

This is a national stage application under 35 U.S.C. § 371 of International Application No. PCT/US2021/049802 filed on Sep. 10, 2021, which claims the benefit of priority under 35 U.S.C. § 119 of U.S. Provisional Application Ser. No. 63/084,140 filed on Sep. 28, 2020, the content of which is relied upon and incorporated herein by reference in their entireties.

### FIELD

The present disclosure relates generally to a glass forming body and more particularly to a glass forming body with improved deformation resistance and method of making a glass article using the same.

### BACKGROUND

In the production of glass articles, such as glass sheets for display applications, including televisions and hand-held devices, such as telephones and tablets, molten glass can be formed into glass sheets by flowing the molten glass over a glass forming body. During a glass forming campaign, the glass forming body is subject to creep and thermal stress, which can cause undesirable sagging of the glass forming body. To counteract this effect, compression forces can be applied to the glass forming body. Over time, however, such compression forces can result in undesirable reduction in glass sheet width. Accordingly, it would be desirable to mitigate sagging of a glass forming body while simultaneously maintaining glass sheet width, especially in processes involving higher molten glass temperatures and/or larger glass forming bodies.

### SUMMARY

Embodiments disclosed herein include a glass forming body. The glass forming body includes a first weir, a second weir, a trough extending between the first and second weirs in a horizontal direction and extending below the first and second weirs in a vertical direction, a first inner surface extending between the first weir and the trough, and a second inner surface extending between the second weir and the trough. Each of first and second inner surfaces extends along an axis oriented at an angle of greater than 0° relative to the vertical direction.

Embodiments disclosed herein also include a method of making a glass article. The method includes flowing molten glass over a glass forming body. The glass forming body includes a first weir, a second weir, a trough extending between the first and second weirs in a horizontal direction and extending below the first and second weirs in a vertical direction, a first inner surface extending between the first weir and the trough, and a second inner surface extending between the second weir and the trough. Each of first and second inner surfaces extends along an axis oriented at an angle of greater than 0° relative to the vertical direction.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic perspective view of a glass forming body;

FIG. 3 is schematic top view of the glass forming body of FIG. 2;

FIG. 4 is a schematic side view of the glass forming body of FIGS. 2 and 3 illustrating the phenomenon of bottom edge contraction;

FIG. 5 is a schematic end view of a glass forming body illustrating the phenomenon of weir sag;

FIG. 6 is schematic top view of an exemplary glass forming body in accordance with embodiments disclosed herein;

FIGS. 7A-7C are schematic partial end cutaway views of the glass forming body of FIG. 6 along lines A-A, B-B, and C-C respectively;

FIG. 8 is schematic top view of an exemplary glass forming body in accordance with embodiments disclosed herein;

FIGS. 9A-9C are schematic partial end cutaway views of the glass forming body of FIG. 8 along lines A-A, B-B, and C-C respectively;

FIG. 10 is schematic top view of an exemplary glass forming body in accordance with embodiments disclosed herein;

FIGS. 11A-11C are schematic partial end cutaway views of the glass forming body of FIG. 10 along lines A-A, B-B, and C-C respectively;

FIG. 12 is schematic top view of an exemplary glass forming body in accordance with embodiments disclosed herein; and

FIGS. 13A-13C are schematic partial end cutaway views of the glass forming body of FIG. 12 along lines A-A, B-B, and C-C respectively.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

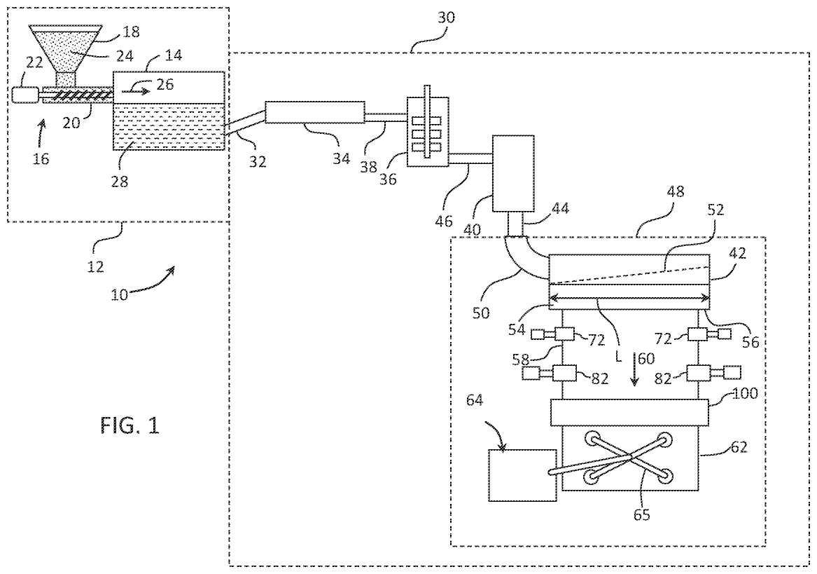

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 includes one or more additional components, such as heating elements (as will be described in more detail herein) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw batch materials 24 that can be fed into melting vessel 14 of glass melting furnace 12, as indicated by arrow 26. Raw batch materials 24 typically comprise one or more glass forming metal oxides and one or more modifying agents. In some examples, raw material delivery device 20 can be powered by motor 22 such that raw material delivery device 20 delivers a predetermined amount of raw batch materials 24 from the storage bin 18 to melting vessel 14. In further examples, motor 22 can power raw material delivery device 20 to introduce raw batch materials 24 at a controlled rate based on a level of molten glass sensed downstream from melting vessel 14. Raw batch materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 100% to about 60% by weight platinum and about 0% to about 40% by weight rhodium. However, other suitable metals can include molybdenum, rhenium, tantalum, titanium, tungsten and alloys thereof. Oxide Dispersion Strengthened (ODS) precious metal alloys are also possible.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw batch materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body 42. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

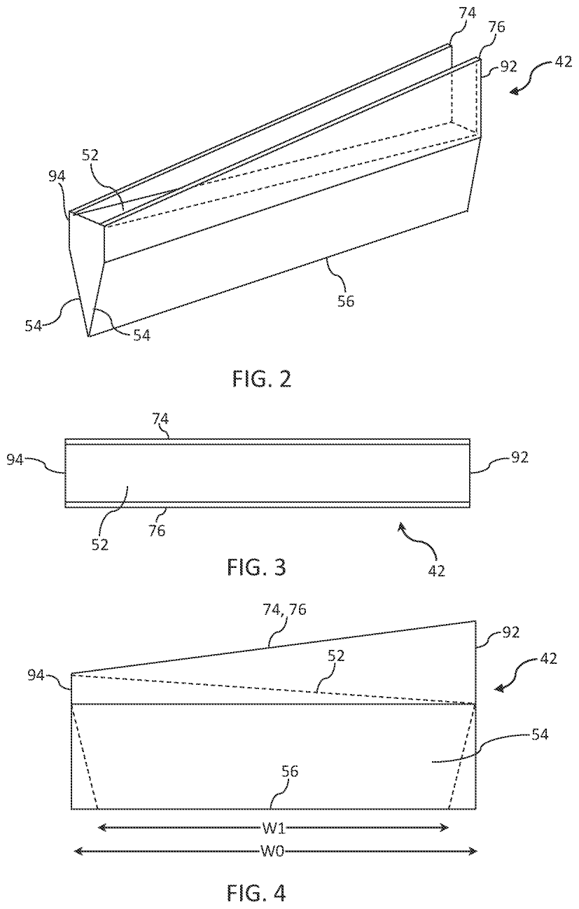

FIG. 2 shows a schematic perspective view of a glass forming body 42. Forming body 42 has an inlet end 92, wherein molten glass is fed into forming body 42 from inlet conduit 50, and a compression end 94 on the opposite side of forming body 42 as inlet end 92. Forming body 42 also has first weir 74 and second weir 76 with trough 52 extending between the first and second weirs 74, 76. Trough 52 is deepest nearest the inlet end 92 of forming body 42 and shallowest nearest the compression end 94 of forming body 42. Forming body 42 also includes converging forming surfaces 54 that meet at bottom edge 56.

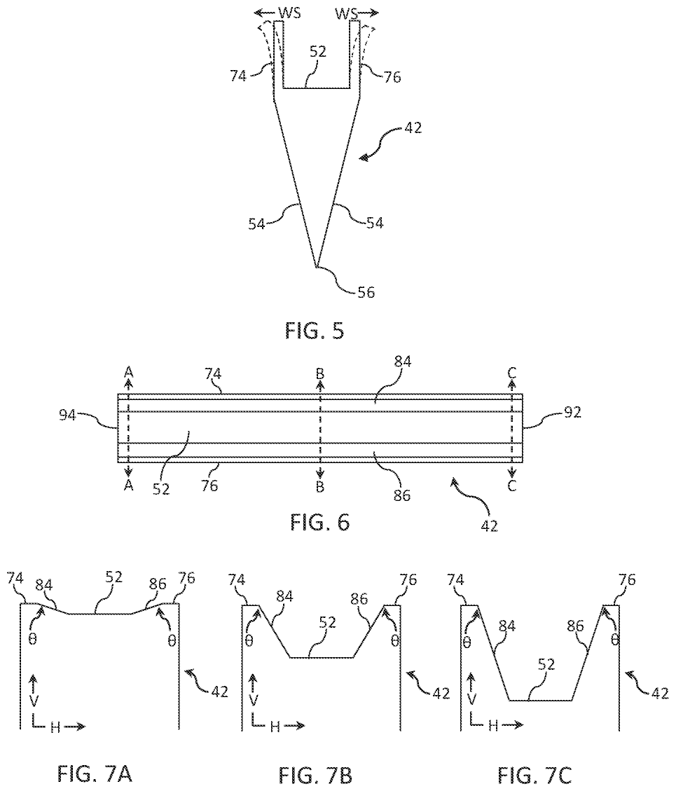

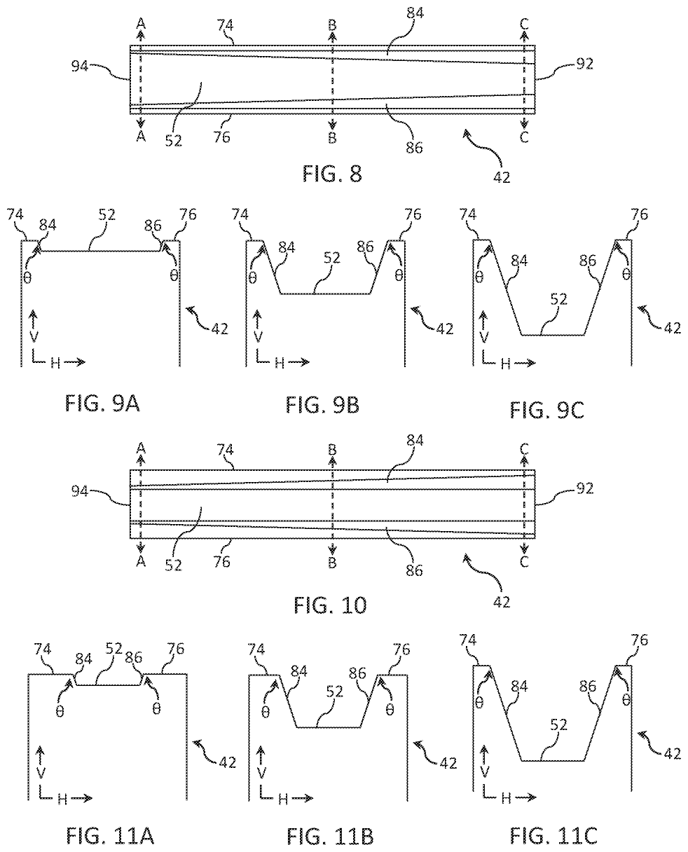

FIG. 3 shows a schematic top view of the glass forming body 42 of FIG. 2, wherein glass forming body 42 includes inlet end 92, compression end 94, trough 52, first weir 72, and second weir 74.

FIG. 4 shows a schematic side view of the glass forming body 42 of FIGS. 2 and 3 illustrating the phenomenon of bottom edge 56 contraction. Specifically, as a result of the process of continually flowing molten glass over glass forming body 42, bottom edge 56 of forming body 42 may contract over a time period, which tends to cause undesirable attenuation in the width of glass ribbon 58. As shown in FIG. 4, a width of bottom edge 56 of forming body 42 at the beginning of the time period is represented by width “W0” and a width of bottom edge 56 of forming body 42 at the end of the time period is represented by the width “W1” wherein W1<W0. The difference between W0 and W1 is referred to herein as bottom edge contraction. Such bottom edge contraction can be mitigated by embodiments disclosed herein.

FIG. 5 shows a schematic end view of a glass forming body illustrating the phenomenon of weir sag. Specifically, over a time period of flowing molten glass over forming body 42, first weir 74 and second weir 76 tend to bow outward as shown by the dashed lines in FIG. 5 (with the degree of weir sag measured as the length of arrows ‘WS’). Such weir sag can be mitigated by embodiments disclosed herein.

FIG. 6 shows a top view of an exemplary glass forming body 42 in accordance with embodiments disclosed herein. FIGS. 7A-7C show schematic partial end cutaway views of the glass forming body 42 of FIG. 6 along lines A-A, B-B, and C-C respectively. Glass forming body 42 includes first weir 74, second weir 76, a trough 52 extending between the first and second weirs 74, 76 in a horizontal direction (H) and below the first and second weirs 74, 76 in a vertical direction (V), a first inner surface 84 extending between the first weir 74 and the trough 52, and a second inner surface 86 extending between the second weir and 76 the trough 52, each of first and second inner surfaces 84, 86 extending along an axis oriented at an angle (θ) of greater than 0° relative to the vertical direction (V).

Glass forming body 42 also includes an inlet end 92 and a compression end 94, wherein a distance between each of the first and second weirs 74, 76 and the trough 52 in the vertical direction (V) is greater at the inlet end 92 than at the compression end 94.

As shown in FIGS. 7A-7C, angle (θ) increases relative to the vertical direction (V) between the inlet end 92 and the compression end 94. Specifically, angle (θ) is smallest relative to the vertical direction (V) near the inlet end 92, as shown in FIG. 7C, and largest relative to the vertical direction (V) near the compression end 94, as shown in FIG. 7A. Between the inlet end 92 and the compression end 94, angle (θ) is larger than at the inlet end 92 and smaller than at the compression end 94, as shown in FIG. 7B.

As shown in FIGS. 6 and 7A-7C, first and second weirs 74, 76 and the trough 52 each include a surface extending a distance in the horizontal direction (H) that is approximately constant between the inlet end 92 and the compression end 94.

FIG. 8 shows a top view of an exemplary glass forming body 42 in accordance with embodiments disclosed herein. FIGS. 9A-9C show schematic partial end cutaway views of the glass forming body 42 of FIG. 8 along lines A-A, B-B, and C-C respectively. Glass forming body 42 includes first weir 74, second weir 76, a trough 52 extending between the first and second weirs 74, 76 in a horizontal direction (H) and below the first and second weirs 74, 76 in a vertical direction (V), a first inner surface 84 extending between the first weir 74 and the trough 52, and a second inner surface 86 extending between the second weir and 76 the trough 52, each of first and second inner surfaces 84, 86 extending along an axis oriented at an angle (θ) of greater than 0° relative to the vertical direction (V).

Glass forming body 42 also includes an inlet end 92 and a compression end 94, wherein a distance between each of the first and second weirs 74, 76 and the trough 52 in the vertical direction (V) is greater at the inlet end 92 than at the compression end 94.

As shown in FIGS. 9A-9C, angle (θ) is approximately constant relative to the vertical direction (V) between the inlet end 92 and the compression end 94. Specifically, angle (θ) is approximately the same relative to the vertical direction (V) near the inlet end 92, as shown in FIG. 9C, near the compression end 94, as shown in FIG. 9A, and between the inlet end 92 and the compression end 94, as shown in FIG. 9B.

As shown in FIGS. 8 and 9A-9C, first and second weirs 74, 76 each comprise a surface extending a distance in the horizontal direction (H) that is approximately constant between the inlet end 92 and the compression end 94 and the trough 52 comprises a surface extending a distance in the horizontal direction (H) that increases between the inlet end 92 and the compression end 94. Specifically, trough 52 comprises a surface that extends a distance in the horizontal direction (H) that is smallest near the inlet end 92, as shown in FIG. 9C, and extends a distance in the horizontal direction (H) that is largest near the compression end 94, as shown in FIG. 9A. Between the inlet end 92 and the compression end 94, trough 52 comprises a surface that extends a distance in the horizontal direction (H) that is larger than at the inlet end 92 and smaller than at the compression end 94, as shown in FIG. 9B.

FIG. 10 shows a top view of an exemplary glass forming body 42 in accordance with embodiments disclosed herein. FIGS. 11A-11C show schematic partial end cutaway views of the glass forming body 42 of FIG. 10 along lines A-A, B-B, and C-C respectively. Glass forming body 42 includes first weir 74, second weir 76, a trough 52 extending between the first and second weirs 74, 76 in a horizontal direction (H) and below the first and second weirs 74, 76 in a vertical direction (V), a first inner surface 84 extending between the first weir 74 and the trough 52, and a second inner surface 86 extending between the second weir and 76 the trough 52, each of first and second inner surfaces 84, 86 extending along an axis oriented at an angle (θ) of greater than 0° relative to the vertical direction (V).

Glass forming body 42 also includes an inlet end 92 and a compression end 94, wherein a distance between each of the first and second weirs 74, 76 and the trough 52 in the vertical direction (V) is greater at the inlet end 92 than at the compression end 94.

As shown in FIGS. 11A-11C, angle (θ) is approximately constant relative to the vertical direction (V) between the inlet end 92 and the compression end 94. Specifically, angle (θ) is approximately the same relative to the vertical direction (V) near the inlet end 92, as shown in FIG. 11C, near the compression end 94, as shown in FIG. 11A, and between the inlet end 92 and the compression end 94, as shown in FIG. 11B.

As shown in FIGS. 10 and 11A-11C, trough 52 comprises a surface extending a distance in the horizontal direction (H) that is approximately constant between the inlet end 92 and the compression end 94 and first and second weirs 74, 76 each comprise a surface extending a distance in the horizontal direction (H) that increases between the inlet end 92 and the compression end 94. Specifically, first and second weirs 74, 76 each comprise a surface that extends a distance in the horizontal direction (H) that is smallest near the inlet end 92, as shown in FIG. 11C, and extends a distance in the horizontal direction (H) that is largest near the compression end 94, as shown in FIG. 11A. Between the inlet end 92 and the compression end 94, first and second weirs 74, 76 each comprise a surface that extends a distance in the horizontal direction (H) that is larger than at the inlet end 92 and smaller than at the compression end 94, as shown in FIG. 11B.

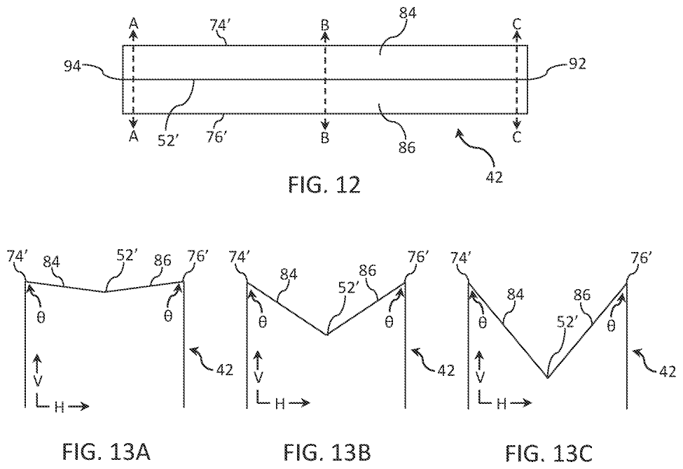

FIG. 12 shows a top view of an exemplary glass forming body 42 in accordance with embodiments disclosed herein. FIGS. 13A-13C show schematic partial end cutaway views of the glass forming body 42 of FIG. 12 along lines A-A, B-B, and C-C respectively. Glass forming body 42 includes first weir 74′, second weir 76′, a trough 52′ extending between the first and second weirs 74′, 76′ in a horizontal direction (H) and below the first and second weirs 74′, 76′ in a vertical direction (V), a first inner surface 84 extending between the first weir 74′ and the trough 52′, and a second inner surface 86 extending between the second weir and 76′ the trough 52′, each of first and second inner surfaces 84, 86 extending along an axis oriented at an angle (θ) of greater than 0° relative to the vertical direction (V).

Glass forming body 42 also includes an inlet end 92 and a compression end 94, wherein a distance between each of the first and second weirs 74′, 76′ and the trough 52′ in the vertical direction (V) is greater at the inlet end 92 than at the compression end 94.

As shown in FIGS. 13A-13C, angle (θ) increases relative to the vertical direction (V) between the inlet end 92 and the compression end 94. Specifically, angle (θ) is smallest relative to the vertical direction (V) near the inlet end 92, as shown in FIG. 13C, and largest relative to the vertical direction (V) near the compression end 94, as shown in FIG. 13A. Between the inlet end 92 and the compression end 94, angle (θ) is larger than at the inlet end 92 and smaller than at the compression end 94, as shown in FIG. 13B.

As shown in FIGS. 12 and 13A-13C, first inner surface 84 contacts second inner surface 86 along trough 52′. Specifically, trough 52′ does not extend a distance in the horizontal direction (H) between first inner surface 84 and second inner surface 86.

In certain exemplary embodiments, such as the embodiments shown in FIGS. 6-13C, angle (θ) can range from about 1° to about 89°, such as from about 5° to about 85°, and further such as from about 10° to about 80°, and yet further such as from about 20° to about 70°, and still yet further from about 30° to about 60° relative to the vertical direction (V), including all ranges and sub-ranges in between.

Embodiments disclosed herein can enable a glass forming body having advantageous properties, including, but not limited to, reduced weir sag and/or reduced bottom edge contraction. For example, embodiments disclosed herein, such as those illustrated in FIGS. 6-13C, can enable a glass forming body with reduced bottom edge contraction, such as at least 50% less bottom edge contraction, when the glass forming body is simultaneously under less compressive force, such as at least 20% less compressive force, as compared to the glass forming body shown in FIGS. 2-3. Accordingly, embodiments disclosed herein include a glass forming body with a longer useable life.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

1. A glass forming body comprising:
a first weir, a second weir, a trough extending between the first and second weirs in a horizontal direction (H) and extending below the first and second weirs in a vertical direction (V), a first inner surface extending between the first weir and the trough, and a second inner surface extending between the second weir and the trough, each of first and second inner surfaces extending along an axis oriented at an angle (θ) of greater than 0° relative to the vertical direction (V).

2. The glass forming body of claim 1, wherein the angle (θ) ranges from about 1° to about 89° relative to the vertical direction (V).

3. The glass forming body of claim 1, wherein the glass forming body comprises an inlet end and a compression end, wherein a distance between each of the first and second weirs and the trough in the vertical direction (V) is greater at the inlet end than at the compression end.

4. The glass forming body of claim 1, wherein the angle (θ) increases relative to the vertical direction (V) between the inlet end and the compression end.

5. The glass forming body of claim 4, wherein the first and second weirs and the trough each comprise a surface extending a distance in the horizontal direction (H) that is approximately constant between the inlet end and the compression end.

6. The glass forming body of claim 4, wherein the first inner surface contacts the second inner surface along the trough.

7. The glass forming body of claim 1, wherein the angle (θ) is approximately constant relative to the vertical direction (V) between the inlet end and the compression end.

8. The glass forming body of claim 7, wherein the first and second weirs each comprise a surface extending a distance in the horizontal direction (H) that is approximately constant between the inlet end and the compression end and the trough comprises a surface extending a distance in the horizontal direction (H) that increases between the inlet end and the compression end.

9. The glass forming body of claim 7, wherein the trough comprises a surface extending a distance in the horizontal direction (H) that is approximately constant between the inlet end and the compression end and the first and second weirs each comprise a surface extending a distance in the horizontal direction (H) that increases between the inlet end and the compression end.

10. A method of making a glass article comprising:
flowing molten glass over a glass forming body, the glass forming body comprising:
a first weir, a second weir, a trough extending between the first and second weirs in a horizontal direction (H) and extending below the first and second weirs in a vertical direction (V), a first inner surface extending between the first weir and the trough, and a second inner surface extending between the second weir and the trough, each of first and second inner surfaces extending along an axis oriented at an angle (θ) of greater than 0° relative to the vertical direction (V).

11. The method of claim 10, wherein the glass forming body comprises an inlet end and a compression end, wherein a distance between each of the first and second weirs and the trough in the vertical direction (V) is greater at the inlet end than at the compression end.

12. The method of claim 10, wherein the angle (θ) increases relative to the vertical direction (V) between the inlet end and the compression end.

13. The method of claim 12, wherein the first inner surface contacts the second inner surface along the trough.

14. The method of claim 10, wherein the first and second weirs each comprise a surface extending a distance in the horizontal direction (H) that is approximately constant between the inlet end and the compression end and the trough comprises a surface extending a distance in the horizontal direction (H) that increases between the inlet end and the compression end.

15. The method of claim 10, wherein the trough comprises a surface extending a distance in the horizontal direction (H) that is approximately constant between the inlet end and the compression end and the first and second weirs each comprise a surface extending a distance in the horizontal direction (H) that increases between the inlet end and the compression end.
